(19) United States
(12) Patent Application Publication
(10) Pub. No.: US 2013/0073607 A1
(43) Pub. Date: Mar. 21, 2013

(54) Registered Users Of An Application

(71) Applicants: Andrey Smirnov, Moscow (RU); Alexey Palazhchenko, Nizhegorodskaya (RU); Rishi Mallik, Chino Hills, CA (US)

(72) Inventors: Andrey Smirnov, Moscow (RU); Alexey Palazhchenko, Nizhegorodskaya (RU); Rishi Mallik, Chino Hills, CA (US)

(21) Appl. No.: 13/234,612

(22) Filed: Sep. 16, 2011

(51) Int. Cl. G06F 15/16

(52) U.S. Cl. 709/203

(57) ABSTRACT

Method and system for identifying contacts of a user of a device, wherein the user is a registered user of an application which is implemented at the device. Contact identifiers are retrieved from a contact list stored at the device, wherein the contact identifiers identify contacts of the user of the device. The retrieved contact identifiers are transmitted to a server associated with the application. The server determines which of the contacts identified by the transmitted contact identifiers are registered users of the application. Indications of the contacts of the user of the device which are determined by the server to be registered users of the application are transmitted from the server to the device.

### TECHNICAL FIELD

The present invention relates to registered users of an application. In particular, the present invention relates to determining registered users of an application.

### BACKGROUND

An application can be implemented at a device wherein a user of the device is a registered user of the application. A server associated with the application can store a list of users who are registered users of the application. For example, each registered user may have an identifier associated with the application (e.g. a username), wherein the server keeps a list of the identifiers of the registered users. Each registered user is associated with at least one instance of the application implemented at one or more devices.

The application may allow the registered users to interact with each other. For example, the application may allow a communication event such as an audio or video call, an instant messaging session or a file transfer to be established between instances of the application at different devices such that two or more registered users of the application can communicate with each other using the instances of the application. As another example, the application may allow a registered user to provide data, such as video data (e.g. by streaming real-time video data as it is captured at a device or by uploading a video file), to a server associated with the application, wherein other registered users can then access the data from the server.

A registered user of the application may wish to determine the identity of other registered users of the application in order to interact with those other registered users using the application. The identifiers associated with the application might not be related to a user's real name, and so it can sometimes be difficult to recognize the identity of other registered users merely from their identifiers stored at the server. Furthermore, it is time-consuming and difficult for a registered user to manually identify particular ones of the other registered users which he knows, or with whom he would like to interact using the application.

### SUMMARY

The inventors have realised that the device which implements the application often has a contact list for the user stored at the device. For example, the contact list may store the landline telephone number, the mobile telephone number and/or the email address of contacts of the user of the device. The information in this native contact list stored at the device can be used by the server associated with the application to determine which of the contacts of the user are also registered users of the application. A list of those contacts of the user who are also registered users of the application may be displayed to the user of the device, such that the user can choose to interact with those contacts using the application if he so desires.

According to a first aspect of the invention there is provided a method of identifying contacts of a user of a device, the user being a registered user of an application which is implemented at the device, the method comprising: retrieving contact identifiers from a contact list stored at the device, said contact identifiers identifying contacts of the user of the device; transmitting the retrieved contact identifiers to a server associated with the application; determining, at the server, which of the contacts identified by the transmitted contact identifiers are registered users of the application; and transmitting, from the server to the device, indications of the contacts of the user of the device which are determined by the server to be registered users of the application.

Advantageously, this method provides a simple way of identifying contacts of the user who are also registered users of the application. In particular, advantageously, indications of the contacts of the user of the device which are determined by the server to be registered users of the application are provided to the device. The user may select, from those indications, one or more registered users with whom he would like to interact using the application, such as by establishing a call with those registered user using the application. Advantageously, the method can be performed automatically so that the user is not required to manually search for registered users of the application.

The step of determining which of the contacts identified by the transmitted contact identifiers are registered users of the application may comprise comparing, at the server, the transmitted contact identifiers with a list of registered users of the application.

In some embodiments, the method further comprises: determining, at the server, presence information relating to the contacts of the user of the device which are also registered users of the application; and transmitting the determined presence information from the server to the device. In this way, the user of the device is provided with the presence information of the contacts who are also registered users of the application. This allows the user to determine whether, and how, to interact with each of the contacts who are also registered users of the application. For example, if the presence information indicates that the contact is offline then the user might not attempt to communicate with that contact using the application, whereas if the presence information indicates that the contact is online then the user may attempt to communicate with that contact using the application.

In some embodiments, the method further comprises: determining, at the server, device capabilities relating to respective devices of the contacts of the user of the device which are also registered users of the application; and transmitting the determined device capabilities from the server to the device. In this way, the user of the device is provided with the device capabilities of the contacts who are also registered users of the application. This allows the user to determine whether, and how, to interact with each of the contacts who are also registered users of the application. For example, if the device capabilities indicate that the contact's device is not capable of displaying video data then the user might not attempt to establish a video call with that contact using the application, whereas if the device capabilities indicate that the contact's device is capable of displaying video data then the user may attempt to establish a video call with that contact using the application.

The method may further comprise displaying, at the device, a list of the contacts of the user of the device which are determined by the server to be registered users of the application. Furthermore, the method may further comprise: receiving at the device, from the user of the device, a selection of one of the contacts from the displayed list; and using the application to establish a call with the selected contact. The call may be established in dependence upon the presence information or the device capabilities transmitted from the server to the device.

In some embodiments the server maintains a first contact list comprising contact identifiers identifying contacts of the user of the device. In these embodiments the method may further comprise determining whether the contact identifiers transmitted from the device to the server differ from the contact identifiers stored in the first contact list, and if the contact identifiers transmitted from the device to the server do differ from the contact identifiers stored in the first contact list updating the first contact list in accordance with the transmitted contact identifiers. The server may also maintain a second contact list comprising contact identifiers which are present in the first contact list and which identify registered users of the application.

The method may further comprise transmitting a request from the application implemented at the device to the server, wherein the step of determining which of the contacts identified by the transmitted contact identifiers are registered users of the application is performed responsive to receiving the request at the server. The step of determining which of the contacts identified by the transmitted contact identifiers are registered users of the application may comprise retrieving the second contact list. Furthermore, the method may further comprise updating the second contact list, responsive to receiving the request at the server, if the first contact list has been changed since the second contact list was last updated or if the list of registered users of the application has been changed since the second contact list was last updated.

The step of transmitting the retrieved contact identifiers to the server may be performed repeatedly (e.g. periodically, that is, from time to time) while the application is implemented at the device.

According to a second aspect of the invention there is provided a system comprising a device and a server associated with an application which is implemented at the device, the system being for identifying contacts of a user of the device, the user being a registered user of the application, wherein the device is configured to: retrieve contact identifiers from a contact list stored at the device, said contact identifiers identifying contacts of the user of the device; and transmit the retrieved contact identifiers to the server; and wherein the server is configured to: determine which of the contacts identified by the transmitted contact identifiers are registered users of the application; and transmit, to the device, indications of the contacts of the user of the device which are determined by the server to be registered users of the application.

According to a third aspect of the invention there is provided a method of identifying contacts of a user of a device, the user being a registered user of an application which is implemented at the device, the method comprising: receiving, at a server associated with the application, contact identifiers which have been retrieved from a contact list stored at the device, said contact identifiers identifying contacts of the user of the device; determining, at the server, which of the contacts identified by the transmitted contact identifiers are registered users of the application; and transmitting, from the server to the device, indications of the contacts of the user of the device which are determined by the server to be registered users of the application.

According to a fourth aspect of the invention there is provided a server for identifying contacts of a user of a device, the user being a registered user of an application which is implemented at the device wherein the server is associated with the application, the server being configured to: receive contact identifiers which have been retrieved from a contact list stored at the device, said contact identifiers identifying contacts of the user of the device; determine which of the contacts identified by the transmitted contact identifiers are registered users of the application; and transmit, to the device, indications of the contacts of the user of the device which are determined by the server to be registered users of the application.

According to a fifth aspect of the invention there is provided a computer program product for identifying contacts of a user of a device, the user being a registered user of an application which is implemented at the device, and the computer program product being embodied on a non-transient computer-readable medium and configured so as when executed on a processor of a server associated with the application to perform the steps of: receiving contact identifiers which have been retrieved from a contact list stored at the device, said contact identifiers identifying contacts of the user of the device; determining which of the contacts identified by the transmitted contact identifiers are registered users of the application; and transmitting, to the device, indications of the contacts of the user of the device which are determined by the server to be registered users of the application.

### BRIEF DESCRIPTION OF THE DRAWINGS

For a better understanding of the present invention and to show how the same may be put into effect, reference will now be made, by way of example, to the following drawings in which:

FIG. 1 shows a system according to a preferred embodiment;

FIG. 2 shows a schematic view of a device according to a preferred embodiment;

FIG. 3 is a flow chart for a process of uploading contact identifiers from a device to a server according to a preferred embodiment; and

FIG. 4 is a flow chart for a process of providing indications of registered users of an application from a server to a device according to a preferred embodiment.

### DETAILED DESCRIPTION

Preferred embodiments of the invention will now be described by way of example only.

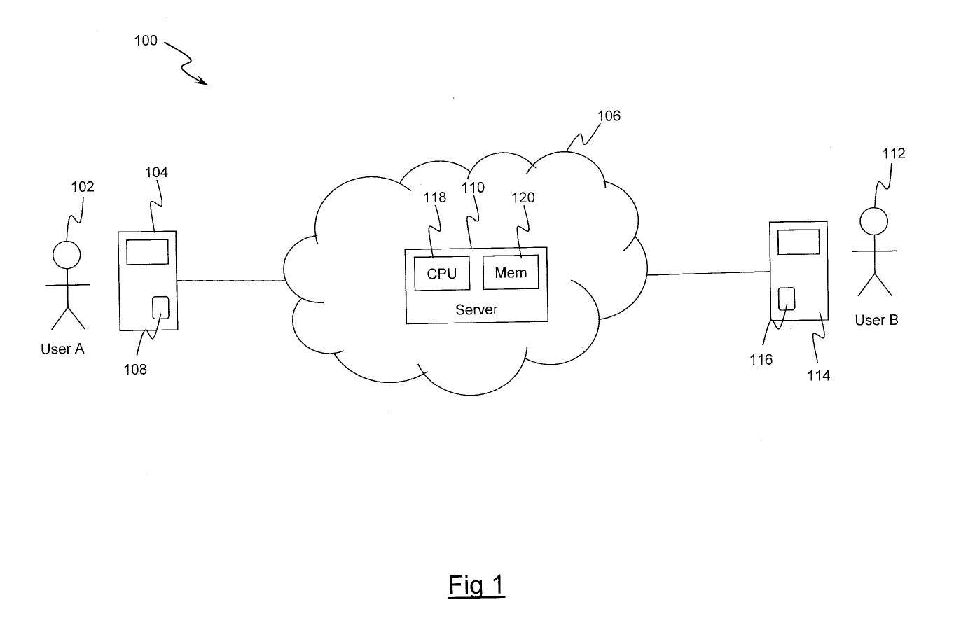

Reference is first made to FIG. 1, which illustrates a system 100 of a preferred embodiment. A first user of the system (User A 102) operates a device 104, The device 104 may be, for example, a mobile phone, a personal digital assistant (“PDA”), a personal computer (“PC”) (including, for example, Windows™, Mac OS™ and Linux™ PCs), a gaming device or other embedded device able to communicate over the system 100. The device 104 is arranged to receive information from and output information to the user 102 of the device. In a preferred embodiment the device 104 comprises a display such as a screen and an input device such as a keypad, joystick, touch-screen, keyboard, mouse and/or microphone. The device 104 can communicate over the system 100 via a network 106, which may be, for example, the Internet. The device 104 can transmit data to, and receive data from, the network 106 over a link as shown in FIG. 1. The system 100 comprises a server 110 with which the device 104 can communicate over the network 106. The server 110 comprises a processor 118 for processing data and a memory 120 for storing data.

The device 104 is configured to execute an application 108, provided by a software provider. The application 108 is a software program executed on a local processor in the device 104 which allows the device 104 to engage in calls and other communication sessions (e.g. instant messaging communication sessions) over the system 100, and may also allow the user 102 to interact with other users of the system 100 in other ways, such as by providing video data to the server 110 and by allowing other users of the system 100 to access the video data from the server 110.

FIG. 1 also shows a second user 112 (User B) who has a device 114 which executes an application 116 which provides the same functionality as application 108 executed at the device 104. The device 114 can transmit data to, and receive data from, the network 106 over a link as shown in FIG. 1. Therefore users A and B (102 and 112) can communicate with each other over the network 106 using the respective instances of the application (108 and 116) executed at the respective devices 104 and 114. There may be more users in the system 100, but for clarity only the two users 102 and 112 are shown in the system 100 in FIG. 1. Both of the users 102 and 112 are registered users of the application. The server 110 is associated with the application (e.g. the server 110 may be operated by the software provider which provides the application to the devices 104 and 114) and keeps a list of the registered users of the application. Other users (not shown in FIG. 1) of the system 100 might not be registered users of the application.

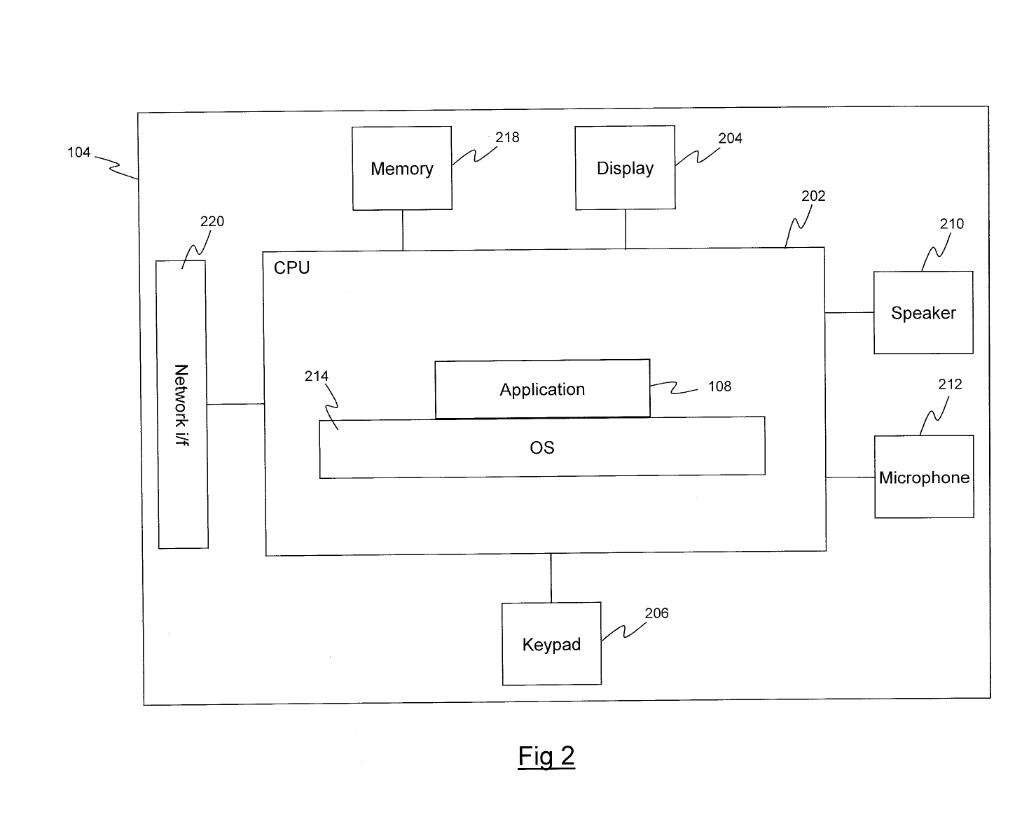

FIG. 2 illustrates a detailed view of the device 104 on which the application 108 is executed. The device 104 comprises a central processing unit (“CPU”) 202, to which is connected a display 204 such as a screen, input devices such as a keypad (or a keyboard) 206 and a pointing device such as a mouse (not shown in FIG. 2). The display 204 may comprise a touch screen for inputting data to the CPU 202. An output audio device 210 (e.g. a speaker) and an input audio device 212 (e.g. a microphone) are connected to the CPU 202. The display 204, keypad 206, output audio device 210 and input audio device 212 are integrated into the device 104. In alternative devices one or more of the display 204, the keyboard 206, the output audio device 210 and the input audio device 212 may not be integrated into the device 104 and may be connected to the CPU 202 via respective interfaces. One example of such an interface is a USB interface. The CPU 202 is connected to a network interface 220 such as a modem for communication with the network 106 for communicating over the system 100. The network interface 220 may be integrated into the device 104 as shown in FIG. 2. In alternative devices the network interface 220 is not integrated into the device 104. The device 104 also comprises a memory 218 for storing data at the device 104.

FIG. 2 also illustrates an operating system (“OS”) 214 executed on the CPU 202. Running on top of the OS 214 is the application 108. The application 108 may for example, be a Qik™ application or a Skype™ application. The operating system 214 manages the hardware resources of the device 104 and handles data being transmitted to and from the network 106 via the network interface 220.

The user 102 stores in the memory 218 of the device 104 a contact list of contacts of the user 102. For example, the device 104 may store one or more telephone numbers (e.g. landline or mobile telephone numbers) of the contacts of the user 102 and/or other identifiers of the contacts such as their email addresses or identifiers in other systems. As an example, when the device 104 is a mobile telephone or a personal computer, the user 102 can maintain the contact list in the memory 218 to store the telephone numbers and/or email addresses of the user's contacts. The user's contacts may, for example, be friends or acquaintances of the user 102.

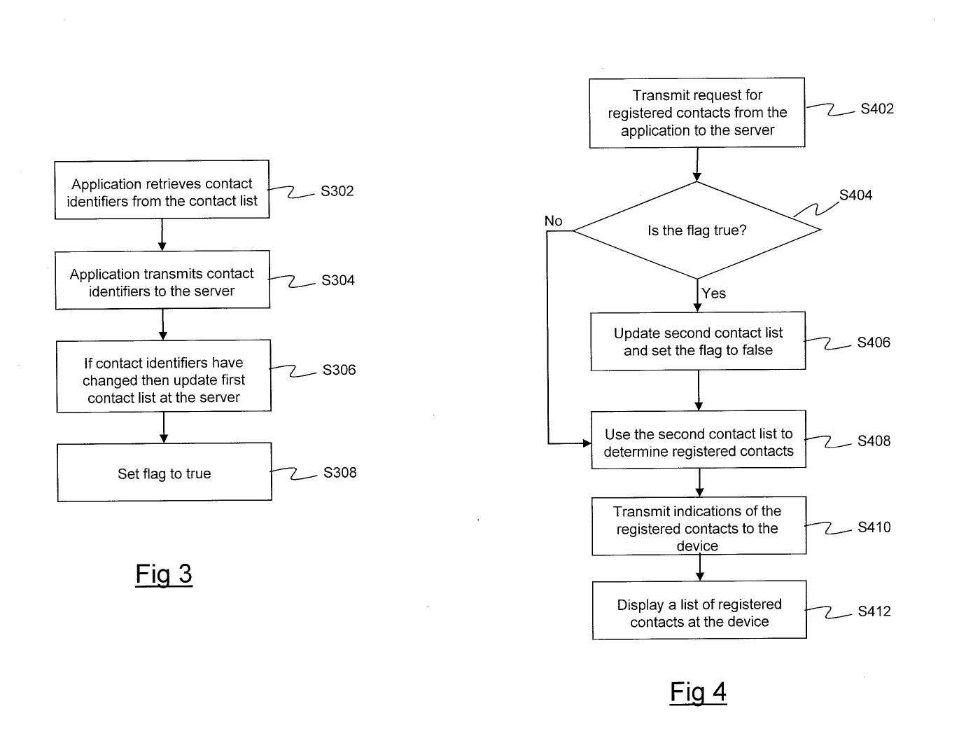

Preferred embodiments of the operation of the system 100 will now be described with reference to FIGS. 3 and 4, in which the information stored in the contact list at the device 104 is used to identify contacts of the user 102 who are also registered users of the application 108.

In step S302 the application 108 retrieves contact identifiers from the contact list stored in the memory 218 of the device 104. As described above the contact identifiers may be telephone numbers, email addresses or other types of identifiers of the contacts of the user 102. In order to retrieve the contact identifiers the application 108 can scan the contact list in the memory 218 of the device 104 to collect all possible identifiers available on the device 104.

In step S304 the application transmits the retrieved contact identifiers to the server 110 over the network 106. The transmission of the contact identifiers can be performed according to any suitable transmission protocol, such as for example the HTTP protocol as REST API calls.

The server 110 maintains a first list of the contact identifiers which it has received from the user 102. This allows the server 110 to maintain a record of the contacts of the user 102. The first list of contact identifiers can be referred to as a “raw” contact list. The server 110 also maintains a second list of contact identifiers which it has received from the user 102 which also identify registered users of the application. Therefore the second list of identifiers is a subset of the first list of identifiers. The second list of identifiers is referred to herein as a “resolved” contact list.

In step S306 the server 110 determines whether the contact identifiers transmitted in step S304 have changed since the first list of contact identifiers for the user 102 was last updated. If there has been no change in the contact identifiers of the user 102 since the first list was last updated at the server 110 then the first list does not need to be updated, and it is therefore not updated. An indication may be transmitted to the device 104 to indicate that the first list of contacts is up to date at the server 110. However, if there have been changes in the contact identifiers of the user 102 since the first list was last updated at the server 110 then the first list does need to be updated, and it is therefore updated according to the contact identifiers that have been received from the device 102 in step S304.

When the first list of contacts has been updated at the server 110 then in step S308 the server 110 sets a flag to ‘true’. When the flag is ‘true’ this indicates that changes have been made to the first list of contact identifiers at the server 110 and that those changes might affect the second list of contact identifiers. Therefore, when the flag is set to ‘true’ this indicates that the second list of contact identifiers might need to be updated before it is used. The flag may also be set to true when the list of registered users of the application changes.

Therefore at the end of the method steps shown in FIG. 3, the device 104 has transmitted contact identifiers for the contacts stored in the contact list at the device 104 to the server 110 and, if necessary the server has updated the first contact list which keeps a record of the contacts of the user 102.

In the method described above with reference to FIG. 3, the contact identifiers are transmitted from the device 104 to the server 110 and then the server 110 determines whether any changes have been made since the last time the first list of contacts was updated at the server 110. In alternative embodiments the application 108 may determine a contact list version for the contact list stored at the device 104. The version can be considered to be a hash of the contact list stored at the device 104. If the contact list doesn't change then the version stays the same, but when the contact list changes, the version is always changed. The application 108 may query the server 110 to determine the last uploaded version of the contact list. If the version hasn't changed then the application 108 does not transmit the contact identifiers to the server 110 because the server 110 already has those contact identifiers. However, if the version has changed then the application 108 does transmit the contact identifiers to the server 110 in step S304 as described above.

As a way to improve the privacy of the user's contact list and to lower network usage, the application 108 can ‘patch’ the first contact list stored at the server 110, that is the application 108 can transmit only the difference (the “delta”) between the version of the contact list stored at the server 110 and the new contact list stored at the device 104. The difference (or “delta”) may be calculated by comparing the server's version of the contact list and the contact list stored at the device 104.

The method shown in FIG. 3 and described above may be performed when the application 108 is first installed at the device 104. The method shown in FIG. 3 and described above may also be performed repeatedly thereafter, e.g. at intervals while the application 108 is implemented at the device 104. The method may be performed periodically, that is, from time to time, such that the first contact list is kept up to date at the server 110.

The user 102 may decide that he would like to know which of his contacts are also registered users of the application. The method steps shown in FIG. 4 and described below relate to a method of determining which of the user's contacts are also registered users of the application.

In step S402 the application 108 transmits a request to the server 110 for the second contact list, that is, the “resolved” contact list. As described above, the resolved contact list is stored at the server 110 and contains identifiers of those contacts of the user 102 who are also registered users of the application.

In step S404 the server 110 determines whether the flag is set to ‘true’. As described above if the flag is set to ‘true’ this indicates that changes have been made to the first contact list stored at the server 110, or that changes have been made to the list of registered users of the application, which may mean that changes are required to be made to the resolved contact list. However, if the flag is not set to ‘true’ then the resolved contact list is up to date and can be relied upon to provide accurate information. If it is determined that the flag is set to ‘true’ then the method proceeds to step S406 whereas if it is determined that the flag is not set to ‘true’ then the method proceeds to step S408 without performing step S406.

In step S406 the server 110 updates the second contact list (i.e. the resolved contact list). In order to do this the server 110 retrieves the contact identifiers in the first contact list stored at the server 110 and compares these contact identifiers to a list of registered users of the application. The list of registered users of the application includes contact identifiers of those users, and may include, for example, their landline telephone number, mobile telephone number and email address. Therefore, the server 110 can determine which of the contacts identified in the first contact list at the server 110 are also registered users of the application by comparing the first list of contact identifiers with the list of registered users of the application. In this way the resolved contact list is updated at the server 110.

When the resolved contact list is updated the flag is set to ‘false’ to indicate that the resolved contact list is up to date.

The method then proceeds to step S408 in which the server 110 uses the resolved contact list to determine those contacts of the user 102 which are also registered users of the application. Step S408 may simply involve retrieving the identifiers from the second contact list, that is, from the resolved contact list.

In step S410 indications of the contacts of the user 102 who are also registered users of the application which were determined in step S408 are transmitted from the server 110 to the device 104. The indications may be identifiers associated with the application 108. For example, where the application is a Qik™ application the indications transmitted in step S410 may be identifiers in the Qik™ system, and where the application is a Skype™ application the indications transmitted in step S410 may be identifiers in the Skype™ system.

In step S412 the device 104 uses the indications received in step S410 from the server 110 to display (e.g. on display 204) to the user 102 a list of the contacts of the user 102 which are also registered users of the application 108. The list of contacts displayed to the user 102 may identify the contacts using any of the identifiers of those contacts, such as their names in the contact list stored at the device 102, their telephone numbers or email addresses or their identifiers associated with the application 108.

Therefore, following the method steps shown in FIG. 4 and described above, the user 102 is provided with a list of his contacts who are also registered users of the application 108. The user 102 may be provided with the option to select one or more of the contacts from the list displayed in step S412 in order to interact with the contact using the application 108. For example, when the user 102 selects one of the displayed contacts, the application 108 may establish a communication event (e.g. an audio or video call, or an instant message session) with the selected contact.

When the application 108 is first implemented at the device 104, the application can upload device capabilities of the device 104 to the server 110. Other instances of the application implemented at other devices for other users also do this. This allows the server 110 to maintain a record (e.g. in the memory 120) of the capabilities of the devices of the registered users of the application 108. When the server 110 transmits the indications of the registered users to the device 104 in step S410 the server 110 may also transmit the device capabilities of the devices of those registered users to the device 104. This allows the device 104, or the user 102, to determine whether, and how, to interact with the registered users using the application 108. For example, if the device capabilities indicate that the device of a contact cannot support video calls then the device 104 or the user 102 can decide not to attempt to establish a video call with that contact. For example, the device 104 may display the list in step S412 and give options to the user 102 for how to interact with each of the contacts in the list, wherein the options given to the user 102 may be determined in accordance with the device capabilities of each of the contacts in the list. Other capabilities of the devices of the contacts in the list displayed in step S412 may include the protocol for communicating with the devices, the type of processor at the devices, the memory capabilities of the devices, the bandwidth with which the devices can communicate over the network 106, and any other capabilities which may be relevant to the way in which the application 108 can interact with the devices.

The server 110 can also communicate with the registered users of the application in order to determine presence information for each of the registered users. The presence information may describe the status of the registered users as, for example, “online”, “busy” or “offline” or any other suitable presence status. The server 110 can keep this information up to date by communicating with the devices of the registered users (e.g. by pinging the devices). The server 110 may communicate with the devices of the registered users using a Notification Protocol in order to determine the presence information for each of the registered users. When the server 110 transmits the indications of the registered users to the device 104 in step S410 the server 110 may also transmit the presence information of the registered users to the device 104. This allows the device 104, or the user 102, to determine whether, and how, to interact with the registered users using the application 108. For example, if the presence information indicates that a contact is offline then the device 104 or the user 102 can decide not to attempt to establish a call with that contact at the present time. For example, the device 104 may display the list in step S412 and give options to the user 102 for how to interact with each of the contacts in the list, wherein the presence information for each of the users may be displayed in the list.

The application 108 may use a notification protocol (e.g. on a second channel) to get notifications about incoming video calls, video mails, etc from the server 110. The notification protocol may be a persistent TCP connection with the server 110. The presence information about contacts is sent via the notification protocol from the server 110 to the device 104. Whenever the application 108 sends a request for the resolved contact list (as in step S402), a presence service at the server 110 updates a list of users of the application for which the presence information is to be followed. The presence information is delivered from the server 110 to the device 104 in real-time for all the registered users in the resolved contact list.

Advantageously the first and second contact lists are stored at the server 110. This means that the application 108 does not need to upload the contact list each time the application 108 requests information about registered users of the application who are associated with the contact list entries. For example, the application 108 does not need to upload the contact list if the server 110 has already stored the current version of the contact list. Furthermore, the second contact list is only updated when the flag is set to ‘true’ as described above, that is, only when changes have been made to the contact list of the user 102 or changes have been made to the list of registered users stored at the server 110.

The processing performed at the server 110 is implemented by the processor 118, and the data stored at the server 110 is stored in the memory 120.

Although in FIG. 1 the server 110 is shown as a single server in the network 106, this is merely for clarity of the description. The server 110 may be implemented as a plurality of server nodes in the system 100 and the functionality of the server 110 described above may be spread over the plurality of server nodes of the system 100. Advantageously, the methods described above are automated such that the contacts of the user 102 who are also registered users of the application 108 are automatically determined and provided to the device 104, without the user 102 being required to perform any manual searching of the registered users of the application 108.

It should be understood that the block, flow, and network diagrams may include more or fewer elements, be arranged differently, or be represented differently. It should be understood that implementation may dictate the block, flow, and network diagrams and the number of block, flow, and network diagrams illustrating the execution of embodiments of the invention.

It should be understood that elements of the block, flow, and network diagrams described above may be implemented in software, hardware, or firmware. In addition, the elements of the block, flow, and network diagrams described above may be combined or divided in any manner in software, hardware, or firmware. If implemented in software, the software may be written in any language that can support the embodiments disclosed herein. The software may be stored on any form of non-transitory computer readable medium, such as random access memory (RAM), read only memory (ROM), compact disk read only memory (CD-ROM), flash memory, hard drive, and so forth. In operation, a general purpose or application specific processor loads and executes the software in a manner well understood in the art.

Furthermore, while this invention has been particularly shown and described with reference to preferred embodiments, it will be understood to those skilled in the art that various changes in form and detail may be made without departing from the scope of the invention as defined by the appendant claims.

What is claimed is:

1. A method of identifying contacts of a user of a device, the user being a registered user of an application which is implemented at the device, the method comprising:
retrieving contact identifiers from a contact list stored at the device, said contact identifiers identifying contacts of the user of the device;
transmitting the retrieved contact identifiers to a server associated with the application;
determining, at the server, which of the contacts identified by the transmitted contact identifiers are registered users of the application; and
transmitting, from the server to the device, indications of the contacts of the user of the device which are determined by the server to be registered users of the application.

2. The method of claim 1 wherein the step of determining which of the contacts identified by the transmitted contact identifiers are registered users of the application comprises comparing the transmitted contact identifiers with a list of registered users of the application.

3. The method of claim 1 further comprising:
determining, at the server, presence information relating to the contacts of the user of the device which are also registered users of the application; and
transmitting the determined presence information from the server to the device.

4. The method of claim 1 further comprising:
determining, at the server, device capabilities relating to respective devices of the contacts of the user of the device which are also registered users of the application; and
transmitting the determined device capabilities from the server to the device.

5. The method of claim 1 further comprising displaying, at the device, a list of the contacts of the user of the device which are determined by the server to be registered users of the application.

6. The method according to claim 5 further comprising:
receiving at the device, from the user of the device, a selection of one of the contacts from the displayed list; and
using the application to establish a call with the selected contact.

7. The method of claim 6 wherein the call is established in dependence upon presence information or device capabilities transmitted from the server to the device.

8. The method according to claim 1 wherein the server maintains a first contact list comprising contact identifiers identifying contacts of the user of the device.

9. The method according to claim 8 further comprising determining whether the contact identifiers transmitted from the device to the server differ from the contact identifiers stored in the first contact list, and if the contact identifiers transmitted from the device to the server do differ from the contact identifiers stored in the first contact list updating the first contact list in accordance with the transmitted contact identifiers.

10. The method according to claim 8 wherein the server maintains a second contact list comprising contact identifiers which are present in the first contact list and which identify registered users of the application.

11. The method of claim 10 wherein the step of determining which of the contacts identified by the transmitted contact identifiers are registered users of the application comprises retrieving the second contact list.

12. The method of claim 1 further comprising transmitting a request from the application implemented at the device to the server, wherein the step of determining which of the contacts identified by the transmitted contact identifiers are registered users of the application is performed responsive to receiving the request at the server.

13. The method of claim 11 further comprising transmitting a request from the application implemented at the device to the server, wherein the step of determining which of the contacts identified by the transmitted contact identifiers are registered users of the application is performed responsive to receiving the request at the server and further comprising updating the second contact list, responsive to receiving the request at the server, if the first contact list has been changed since the second contact list was last updated or if a list of registered users of the application has been changed since the second contact list was last updated.

14. The method of claim 1 wherein the step of transmitting the retrieved contact identifiers to the server is performed repeatedly while the application is implemented at the device.

15. The method of claim 1 wherein the indications transmitted from the server to the device are identifiers associated with the application.

16. The method of claim 1 wherein the contact identifiers retrieved from the contact list stored at the device comprise at least one of: (i) a landline telephone number, (ii) a mobile telephone number, and (iii) an email address.

17. A system comprising a device and a server associated with an application which is implemented at the device, the system being for identifying contacts of a user of the device, the user being a registered user of the application, wherein the device is configured to:
retrieve contact identifiers from a contact list stored at the device, said contact identifiers identifying contacts of the user of the device; and
transmit the retrieved contact identifiers to the server; and wherein the server is configured to:
determine which of the contacts identified by the transmitted contact identifiers are registered users of the application; and
transmit, to the device, indications of the contacts of the user of the device which are determined by the server to be registered users of the application.

18. A method of identifying contacts of a user of a device, the user being a registered user of an application which is implemented at the device, the method comprising:
receiving, at a server associated with the application, contact identifiers which have been retrieved from a contact list stored at the device, said contact identifiers identifying contacts of the user of the device;
determining, at the server, which of the contacts identified by the transmitted contact identifiers are registered users of the application; and
transmitting, from the server to the device, indications of the contacts of the user of the device which are determined by the server to be registered users of the application.

19. A server for identifying contacts of a user of a device, the user being a registered user of an application which is implemented at the device wherein the server is associated with the application, the server being configured to:
receive contact identifiers which have been retrieved from a contact list stored at the device, said contact identifiers identifying contacts of the user of the device;
determine which of the contacts identified by the transmitted contact identifiers are registered users of the application; and
transmit, to the device, indications of the contacts of the user of the device which are determined by the server to be registered users of the application.

20. A computer program product for identifying contacts of a user of a device, the user being a registered user of an application which is implemented at the device, and the computer program product being embodied on a non-transitory computer-readable medium and configured so as when executed on a processor of a server associated with the application to perform the steps of:
receiving contact identifiers which have been retrieved from a contact list stored at the device, said contact identifiers identifying contacts of the user of the device;
determining which of the contacts identified by the transmitted contact identifiers are registered users of the application; and
transmitting, to the device, indications of the contacts of the user of the device which are determined by the server to be registered users of the application.
